(19) United States
(12) Patent Application Publication
(10) Pub. No.: US 2003/0081211 A1
(43) Pub. Date: May 1, 2003

(54) Light source device and image reading apparatus

(75) Inventors: Tomonori Nishio, Kanagawa (JP); Kazutoshi Matsumoto, Kounosu-shi (JP)

Correspondence Address: SUGHRUE MION, PLLC, 2100 Pennsylvania Avenue, N.W., Washington, DC, 20037-3213, US

(73) Assignee: FUJI PHOTO FILM CO., LTD.

(21) Appl. No.: 10/256,247

(22) Filed: Sep. 27, 2002

(30) Foreign Application Priority Data
Sep. 28, 2001 (JP) 2001-303779

(51) Int. Cl. G01B 11/00

(52) U.S. Cl. 356/390

(57) ABSTRACT

In order that blemish-erasing for an original can be carried out precisely and degradation of quality of read image does not occur, a light source device and an image reading apparatus comprising a first light source section that emits a first light for reading image information of an image recorded on a transparent original or a reflection original, a second light source section that emits a second light for detecting a defect portion on the original or an optical path, and a filter that blocks a light which is included in the first light and whose wavelength is substantially the same as that of the second light, are provided, thereby degradation of quality of read image caused by sub-emission energy is prevented.

### BACKGROUND OF THE INVENTION

1. Field of the Invention

The present invention relates to a light source device and an image reading apparatus, and particularly relates to a light source device and an image reading apparatus in which a light emitting element is used as a light source.

2. Description of the Related Art

Image reading devices have been realized in which illumination light is irradiated onto a reflection original such as a photographic print or a transparent original such as a photographic film, and the reflected or transmitted light, which includes image information of the image recorded on the original, from the original is received by an image reading sensor such as a CCD (charge coupled device) such that the image recorded on the original is read. Processing such as various types of correction are carried out on the image data obtained by the reading. Thereafter, the image is recorded onto a recording material such as a photographic printing paper, or the image is displayed on a display. Such image reading devices are advantageous in that it is easy to make automatic operations from the reading of the image recorded on the original to the recording of the image onto the recording material or the image is displayed on the display.

In the image reading devices described above, conventionally, a white light source such as a halogen lamp or the like has been used as the light source for illuminating the original. However, in recent years, devices have been realized in which, instead of the white light source, an LED (a light emitting diode) light source is used. The LED light source is structured by a plurality of LED elements, which emit lights of colors of red (R), green (G), and blue (B), being arrayed on a substrate. By using the LED light source, filters for color separation of the light emitted from the white light source are not necessary, thus making the structure of the device more simple. Further, setting of conditions, such as respective color balances and the like, can be simplified.

If there are blemishes on a surface of a photographic film, a light illuminated on the surface of the photographic film is scattered by the blemishes. Thus, an image reading sensor cannot obtain and detect a proper quantity of the light, which corresponds to image information of an image recorded on the photographic film. As the result, an image defect portion due to the blemishes are visible on an outputted image.

In order to reduce adversely affecting on an image, which is caused by a blemish or a scratch on the surface of the film, or a dust or the like on an optical path from a light source to the film (hereinafter, a defect portion), technique as follows is proposed. An image is read by an invisible light, which does not respond to image information of color-wavelength (wavelength in a visible light region), such as infrared (IR), to detect only a portion, at which light is scattered, caused by the defect portion. Then, image processing is carried out such that an image defect part caused by the defect portion is corrected in a digital (electrical) manner on the basis of image information in the vicinity of the image defect part.

Correction can be performed more precisely by an electrical image correction using an invisible light, compared to by an optical blemish-erasing. In a case in which a light emitting element is used as a light source, an invisible light may be included in irradiated light irradiated from the light emitting element which emits mainly a visible light. In FIGS. 5A and 8B, an example is shown in which a LED (light emitting diode), emitting light of color of red, is used as a light source. As shown in the drawings, a visible light and an invisible light are emitted from the LED, and there is a large difference between emission energy of the visible light and that of the invisible light (see FIG. 8A). However, when these lights (the visible light and the invisible light) transmit through a photograph film, the emission energy of the visible light (red) becomes small, but the emission energy of the invisible light (a sub-emission energy) does not become so small compared to the emission energy of the visible light (red). Namely, after these lights from the LED transmits the photograph film, the sub-emission energy becomes conspicuous. Therefore, in the case in which the light emitting element is used as the light source, detecting precision for detecting a light-scattering portion caused by the defect portion is lowered. Further, there is a demerit that degradation of quality of image, such as lowering brightness of the read image, may occur. Note that higher the density of light, the sub-emission energy becomes more conspicuous.

Moreover, when an ambient temperature at a portion in which a light emitting element is disposed is changed, or temperature is changed due to the light emitting element itself heating, emission spectrum of light irradiated from the light emitting element is changed. Therefore, image data read after the temperature is changed does not coincide with image data read before the temperature is changed. Accordingly, color tint and brightness of read image becomes unstable, thereby degradation of quality of image occurs.

### SUMMARY OF THE INVENTION

In view of the aforementioned circumstances, it is an object of the present invention to provide a light source device and an image reading apparatus in which blemish-erasing for an original can be carried out precisely and degradation of quality of read image does not occur.

A first aspect of the present invention is a light source device comprising: a first light source section that emits a first light for reading image information of an image recorded on a transparent original or a reflection original; a second light source section that emits a second light for detecting a defect on the original or on an optical path; and a filter that blocks light, included in the first light, whose wavelength is substantially the same as that of the second light.

In a second aspect of the present invention according to the first aspect, the first light source section is a first light emitting element group formed by a plurality of light emitting elements that emit lights having different wavelengths on the basis of wavelengths of the colors of red, green and blue, and the second light source section is a second light emitting element group formed by a plurality of light emitting elements that emit infrared light.

In a third aspect of the present invention according to the second aspect, the filter is disposed in the vicinity of an emitting surface of the first light emitting element group.

In a fourth aspect of the present invention according to the second or the third aspect, the first light emitting element group and the second light emitting element group are mounted on respective separate substrates.

In a fifth aspect of the present invention according to the fourth aspect, an axis of an optical path of light emitted from the second light emitting element group and reflected at the filter is the same as an axis of an optical path of light emitted from the first light emitting element group and transmitted through the filter.

In a sixth aspect of the present invention according to the second or the third aspect, the first light emitting element group and the second light emitting element group are both disposed on a single substrate, and the filter is mounted on only an emitting surface of the first light emitting element group.

In a seventh aspect of the present invention according to the fourth or the sixth aspect, the device further comprises a temperature detecting section for detecting a temperature at a portion of the substrate on which the first light emitting element group is mounted, and a temperature adjusting section for adjusting the temperature at the portion of the substrate on which the first light emitting element group is mounted on the basis of the temperature detected by the temperature detecting section.

An eighth aspect of the present invention is an image reading apparatus, in which an image recorded on a transparent original or a reflection original is read, comprising a light source device including a first light source section that emits a first light for reading image information of the image, a second light source section that emits a second light for detecting a defect on the original or an optical path, and a filter that blocks light, included in the first light, whose wavelength is substantially the same as that of the second light, and an image reading section for reading the image information of the image recorded on the original by receiving light that is emitted from the light source device and reflected by or transmitted through the original.

In a ninth aspect of the present invention according to the fourth aspect, the filter transmits through lights having wavelengths of colors of the red, green and blue, and the infrared is reflected at the filter.

In a tenth aspect of the present invention according to the fifth aspect, the first light source section and the second light source section are disposed such that an emitting surface of the first light source section and an emitting surface of the second light source section are substantially orthogonal to each other, and the filter is disposed such that a surface thereof is inclined by substantially 45 degrees with respect to the respective irradiating surfaces.

An eleventh aspect of the present invention is a light source device comprising: a light source section that emits a light for reading image information of an image recorded on a transparent original or a reflection original; and a filter that blocks invisible light included in the light emitted from the light source, wherein the light source section is a light emitting element group formed by a plurality of light emitting elements that emit lights having different wavelengths on the basis of wavelengths of the colors of red, green and blue.

In a twelfth aspect of the present invention according to the eleventh aspect, the filter is disposed in the vicinity of an emitting surface of the light emitting element group.

In the light source device of the first aspect of the present invention, the first light source section that emits the first light for reading image information of the image recorded on the transparent original or the reflection original, and the second light source section that emits the second light for enabling to detect the defect portion on the original or the optical path of the light source section (for example, blemish on the original or dust on the optical path), are provided. As the first light for reading image information of the image recorded on the transparent original or the reflection original, lights in a visible light region, corresponding to predetermined wavelengths (colors), for reading image are used. As the second light for detecting blemish on the original, dust on the optical path and the like, a light in an invisible region is used. In a case in which a light emitting element (LED) is used as the first light source section, the first light source section emits not only lights for reading image but also a light whose wavelength is substantially the same as that of the second light for detecting blemish, dust or the like, emitted from the second light source section. If a sub-emission energy of this light is large, degradation of quality of image, such as brightness-lowering of the read image, occurs when an image is read by an image reading apparatus using the light source device of the present invention. Accordingly, degradation of quality of image due to sub-emission energy is prevented by blocking (cutting) a light which is included in the first light from the first light source section and whose wavelength is substantially the same as that of the second light from the second light source section.

In the light source device of the second aspect of the present invention, because the first light source section is formed by a plurality of light emitting elements and the second light source section is formed by a plurality of light emitting elements, heating value is relatively small, therefore, emission efficiency of the first light source section and the second light source section becomes high. Further, each light of color can be independently emitted by emission-controlling of each of the light emitting elements (by switching the light emitting elements per color). Moreover, the first light source section or the second light source section can emits respective lights by performing switching between the first light source section and the second light source.

If the filter is disposed away from the emitting surface of the first light emitting element group, there is a possibility that a portion of the light (which is included in the first light from the first light emitting element group and whose wavelength is substantially the same as that of the second light from the second light emitting element group for detecting blemish, dust, or the like) does not pass through the filter. In this case, degradation of quality of image, such as brightness lowering of the read image, occurs when an image is read by an image reading apparatus using this kind of the light source device. Accordingly, in the light source device of the third aspect of the present invention, the filter is disposed in the vicinity of the emitting surface of the first light emitting element group. By this, the light, whose wavelength is substantially the same as that of the light for detecting blemish, dust, or the like, in the light from the first light emitting element group, can be cut efficiently, and therefore, only the lights for reading image can be reached to the image. Thus, degradation of quality of image can be presented.

In the light source device of the fourth aspect of the present invention, the first light emitting element group is mounted on a first substrate and the second light emitting element group is mounted on a second substrate which is different from the first substrate. Accordingly, degree of freedom regarding of a layout (arrangement) of the first light emitting element group and the second light emitting element group becomes high. Therefore, the light source device can be made small without degradation of quality of read image.

In the light source device of the fifth aspect of the present invention, in a case in which the first light emitting element group is mounted on the first substrate and the second light emitting element group is mounted on the second substrate which is different from the first substrate, the axis of the optical path of the reflected light which is emitted from the second light emitting element group and reflected at the filter, is the same as the axis of the optical path of the transmitted light which is emitted from the first light emitting element group and transmits through the filter. Namely, because degree of freedom regarding of a layout (arrangement) of the first light emitting element group and the second light emitting element group is high, disposed-positions of the first light emitting element group, the second light emitting element group and the filter can be suitably changed. Accordingly, it is possible to arrange the first light emitting element group, the second light emitting element group and the filter such that the axis of the optical path of the reflected light which is emitted from the second light emitting element group and reflected at the filter, is the same as the axis of the optical path of the transmitted light which is emitted from the first light emitting element group and transmits through the filter. Therefore, the light source device can be made small while maintaining quality of read image.

In the light source device of the sixth aspect of the present invention, because the first light emitting element group is mounted on a substrate and the second light emitting element group is mounted on the substrate which is as the same as the substrate on which the first light emitting element group is mounted, it is not necessary to increase a number of substrates. Further, because the filter is mounted on the emission surface of the first light emitting element group, the light which is included in the light from the first light emitting element group and whose wavelength is substantially the same as the light for detecting blemish, dust, or the like, can be cut. Therefore, degradation of quality of image due to the sub-emission energy can be prevented.

In a case in which temperature of the light emitting element is changed, degradation of quality of image read by the image reading apparatus using the light source device occurs. Therefore, it is desired that the temperature of the light emitting element is maintained by a predetermined temperature. Accordingly, in the light source device of the seventh aspect of the present invention, the temperature detecting section detects temperature of the portion of the substrate on which the first light emitting element group is mounted. By detecting temperature periodically, it is possible to detect variation of temperature at the portion of the substrate on which the first light emitting element group is mounted. For example, on the basis of the temperature detected by the temperature detecting section, in a case in which the detected temperature is not the predetermined temperature, the temperature adjusting section adjusts the temperature of the portion of the substrate on which the first light emitting element group is mounted such that the temperature at the portion of the substrate on which the first light emitting element group is mounted is maintained in the predetermined temperature by radiating heat or heating. Thus, the temperature of the first light emitting element is maintained in the predetermined temperature and degradation of quality of image due to variation of the temperature of the first light emitting element can be prevented. Further, in a case in which the first light emitting element group is mounted on the first substrate and the second light emitting element group is mounted on the second substrate which is different from the first substrate, by that the temperature adjusting section is mounted only on the first substrate, cost can be reduced. As the temperature adjusting section, an electric heating device, a fan, a Peltier element can be used.

In the image reading apparatus of the eight aspect of the present invention, the reflected light or the transmitted light, emitted from the light source device in accordance with one of the first aspect through the seventh aspect and reflected on or transmitted through the image recorded on the original is received by the image reading section, and the image information of the image recorded on the original is read. In the image reading apparatus, the light source device, in which the light which is included in the light for reading image and whose wavelength is substantially the same as that of the light for detecting blemish, dust or the like, can be blocked (cut), is used. Therefore, degradation of quality of image, due to that a light whose wavelength is substantially the same as that of the light from the second light source section (the second light emitting element group) is included in a light from the first light source section (the first light emitting element group), can be prevented. Accordingly, high quality image reading can be carried out. As the image reading section, for example, a CCD such as a line CCD sensor, an area CCD sensor or the like, or any photoelectric transfer element can be used.

In the present invention, a light source device and an image reading apparatus comprises a visible light source section that emits a visible light in a visible light region for reading image information of an image recorded on an original, and an invisible light source section that emits an invisible light in an invisible light region for detecting a defect portion (a blemish on the original or a dust on an optical path). A diffusing member, that makes irradiated light on a surface of the original substantially uniform, is disposed on optical paths of the both visible light source section and invisible light source section. In the image processing section, on the basis of the image defect portion detection information for blemish on the original or dust on the optical path, which is obtained by reading image with the invisible light of the invisible light source, image information read by the visible light of the visible light source is corrected.

In the light source device of the ninth aspect of the present invention, the filter transmits through lights having wavelengths of colors of the red, green and blue, which are lights in wavelength range of visible light. Also, light in infrared wavelength range, which is wavelength range of invisible light, is reflected at the filter. Accordingly, lights in wavelength range of visible light are used efficiently, and light in infrared wavelength range, as light for detecting a defect on the original or on an optical path, is also used efficiently.

In the light source device of the tenth aspect of the present invention, due that the first light source section and the second light source section are disposed such that the emitting surface of the first light source section and the emitting surface of the second light source section are substantially orthogonal to each other, a region at which each of optical paths overlap can be minimized. Also, due to that the filter is disposed such that the surface thereof is inclined by substantially 45 degrees with respect to the respective irradiating surfaces, optical paths of the transmitted light and the reflected light can be guided to the substantially same optical path easily.

In the light source device of the eleventh aspect of the present invention, degradation of quality of image caused by sub-emission energy at the time of image reading can be prevented, due to that the light source section is structured by the light emitting element group which is formed by the plurality of light emitting elements that emit lights having different wavelengths on the basis of wavelengths of the colors of red, green and blue, and the filter blocks invisible light included in the lights emitted from the light source.

In the light source device of the twelfth aspect of the present invention, due to that the filter is disposed in the vicinity of the emitting surface of the light emitting element group, unnecessary light (infrared) can be cut efficiently, therefore, only light necessary for image reading can be reached on the image. Accordingly, degradation of quality of read image can be prevented.

### BRIEF DESCRIPTION OF THE DRAWINGS

FIG. 1 is a schematic structural view illustrating a digital laboratory system relating to a first embodiment of the present invention.

FIG. 2 is an exterior view illustrating the digital laboratory system.

FIG. 3 is a schematic structural perspective view illustrating an optical system of a CCD scanner section relating to the first embodiment of the present invention.

FIGS. 4A-4C are schematic explanation views illustrating a light source and a filter relating to the first embodiment of the present invention, FIG. 4A is a schematic side view illustrating the light source and the filter, FIG. 4B is a schematic plane view illustrating a substrate on which a LED chip group is mounted, and FIG. 4C is a schematic plane view illustrating the filter.

FIGS. 5A-5C are schematic explanation views illustrating a light source and a filter relating to a second embodiment of the present invention, FIG. 5A is a schematic side view illustrating the light source and the filter, FIG. 5B is a schematic plane view illustrating a substrate on which a LED chip group is mounted, and FIG. 5C is a schematic plane view illustrating the filter.

FIG. 6 is a schematic structural side view illustrating an optical system of a CCD scanner section relating to the second embodiment of the present invention.

FIG. 7 is a schematic plane view illustrating a positional relationship between a LED chip group and a filter relating to another embodiment of the present invention.

FIGS. 8A and 8B are graphs showing comparison of emission energy and sub-emission energy when LED is used as a light source.

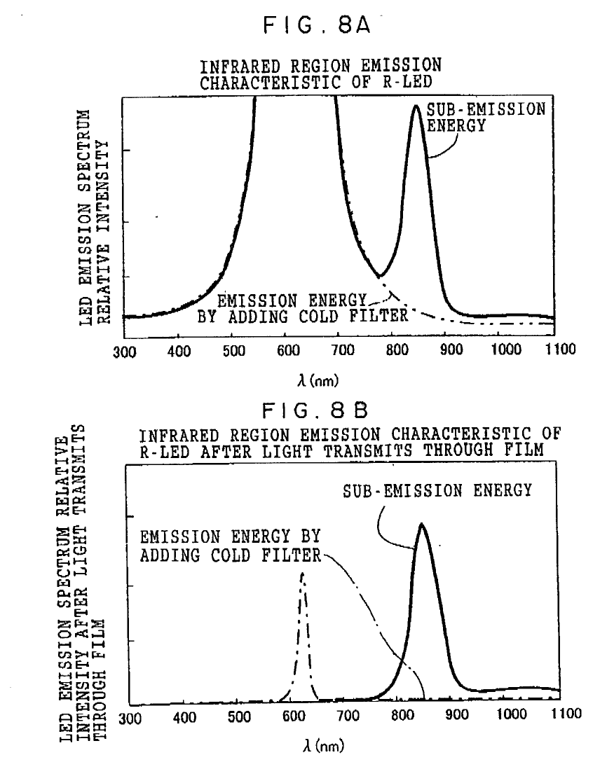

FIGS. 9A-9C are schematic explanation views illustrating a light source and a filter relating to another embodiment of the present invention, FIG. 9A is a schematic side view illustrating a light source and a filter, FIG. 9B is a schematic plane view illustrating a substrate on which a LED chip group is mounted, and FIG. 9C is a schematic plane view illustrating the filter.

### DESCRIPTION OF THE PREFERRED EMBODIMENTS

Referring to drawings, embodiments of the present invention will be described hereinafter in detail.

[First Embodiment]

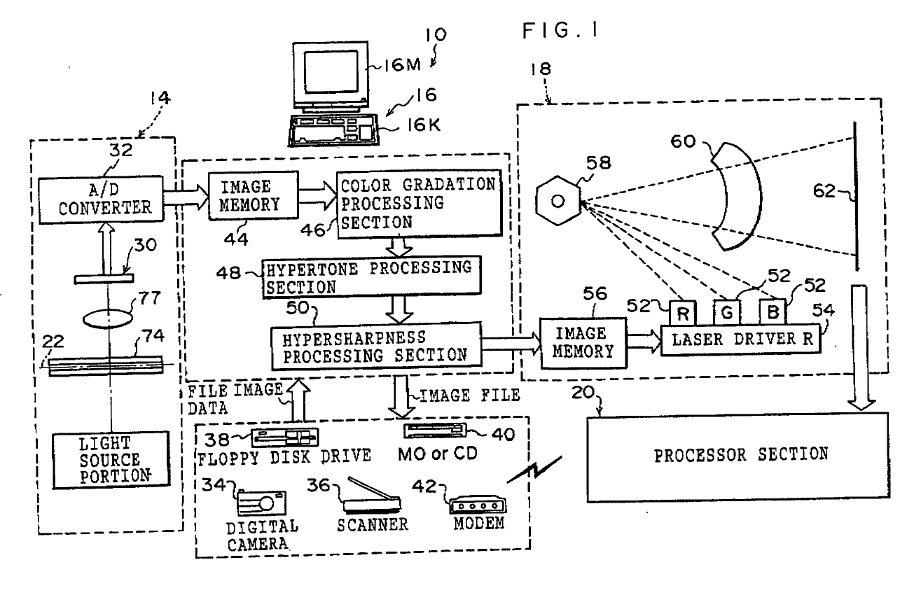

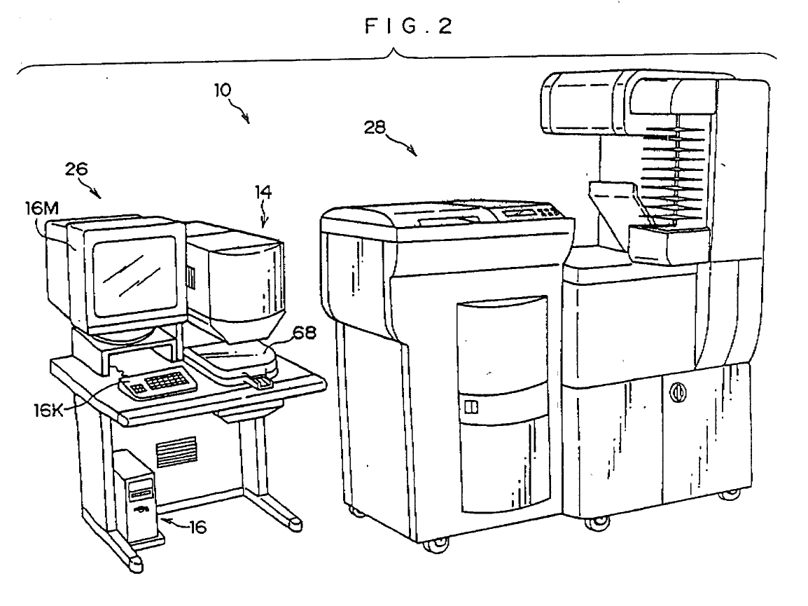

FIGS. 1 and 2 illustrate the schematic structure of a digital laboratory system 10 relating to the first embodiment of the present invention.

As illustrated in FIG. 1, the digital laboratory system 10 includes a CCD scanner section 14, an image processing section 16, a laser printer section 18, and a processor section 20. The CCD scanner section 14 and the image processing section 16 are formed integrally as an input section 26 illustrated in FIG. 2. The laser printer section 18 and the processor section 20 are formed integrally as an output section 28 illustrated in FIG. 2. The CCD scanner section 14 is for reading a frame image recorded on a photographic film such as a negative film or a reversal film. Examples of photographic films whose frame images can be the object of reading include 135 size photographic films, 110 size photographic films, photographic films on which a transparent magnetic layer is formed (240 size photographic films, known as APS films), and 120 size and 220 size (Brownie size) photographic films. The CCD scanner section 14 reads the frame image which is the object of reading by a CCD sensor 30. After A/D conversion at an A/D converter 32, the image data is outputted to the image processing section 16.

The image processing section 16 is structured such that image data (scan image data) outputted from the CCD scanner section 14 is inputted to the image processing section 16. Further, image data obtained by photographing by a digital camera 34 or the like, image data obtained by reading an original (e.g., a reflective original) by a scanner 36 (a flat-bed type scanner), image data generated at another computer and stored in a floppy disk (FD) by a floppy disk drive 38, an MO disk by an MO drive or a CD by a CD drive 40, communication image data received via a modem 42, or the like may be inputted to the image processing section 16 from the outside.

At the image processing section 16, the inputted image data is stored in an image memory 44, and image processings such as respective types of corrections performed by a color gradation processing section 46, a hypertone processing section 48, a hypersharpness processing section 50 and the like are carried out. Further, depending on setting, image processing such as a blemish-erasing correction is carried out in accordance with the image data read by an infrared (this will be described later). The data which has been subjected to those image processings is outputted as image data for recording to the laser printer section 18. Further, the image processing section 16 can output image data, which has been subjected to image processing, to the exterior as an image file (e.g., can output the image data onto a recording medium such as FD, MO, or CD, or can transmit the image data to another information processing device via a communication line, or the like).

The laser printer section 18 is provided with a red (R), a green (G) and a blue (B) laser light sources 52. A laser driver 54 is controlled such that laser light modulated in accordance with the image data for recording which has been inputted from the image processing section 16 (and temporarily stored in an image memory 56) is irradiated onto a photographic printing paper. An image is recorded onto the photographic printing paper 62 due to this scanning exposure (in the present embodiment, an optical system mainly using a polygon mirror 58 and an fθ lens 60). Further, in the processor section 20, the photographic printing paper 62, on which the image has been recorded by scanning exposure in the laser printer section 18, is subjected to various processings such as color developing, bleaching fixing, washing and drying. An image is thereby formed on the photographic printing paper 62.

(Structure of Area CCD Scanner)

Next, the structure of the CCD scanner section 14 will be described. In the present embodiment, explanation will be given of the digital laboratory system 10 in a case in which the 135 size photographic film is used.

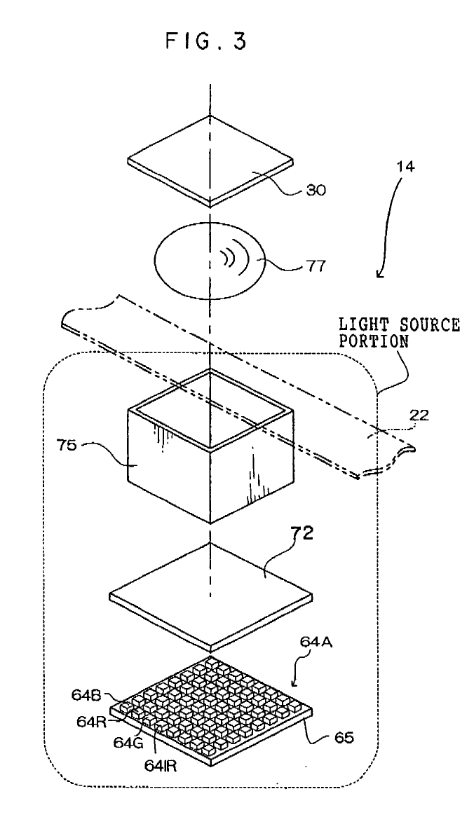

FIG. 3 illustrates the schematic structure of an optical system of the CCD scanner section 14. The optical system is provided with a substrate 65 on which a LED chip group 64A is mounted. The LED chip group 64A includes a plurality of LED chips 64R, 64G, 64B and 64IR. The LED chips 64R, 64G and 64B emit respective lights of colors of a red (R), a green (G) and a blue (B) as light sources which irradiate the photographic film 22 with respective visible lights. The LED chips 64IR emit an infrared (IR) as light sources which irradiate the photographic film 22 with an invisible light for a detecting a defect portion.

The LED chip group 64A is structured such that the LED chips 64R, 64G, 64B and 64IR are arranged closely (densely) in a plane manner on the substrate 65 along a direction in which the photographic film 22 is conveyed (a longitudinal direction of the photographic film 22) and a widthwise direction of the photographic film 22. (The LED chips are arranged in R, G, B and IR order. For example, one of the LED chips 64R is positioned next to one of the LED chips 64G, the one of the LED chips 64G is positioned next to one of the LED chips 64B, the one of the LED chips 64B is positioned next to one of the LED chips 64IR, and the one of the LED chips 64IR is positioned next to one of the LED chips 64R.) The LED chips are controlled such that respective lights of colors can be emitted independently (namely, emission of light of one color can be switched to that of another color). Therefore, the LED chip group 64A can emit respective R, G, B lights without non-uniformity of light quantity.

The LED chips 64R, 64G, 64B and 64IR may be arranged on the substrate 65 in a different manner. The LED chips 64R, 64G, 64B and 64IR may be arranged such that there are a plurality of columns, each formed by LED chips of a single color of one of R, G, B or JR being aligned in a line manner along a direction in which the photographic film 22 is conveyed (the longitudinal direction of the photographic film 22) or the widthwise direction of the photographic film 22, and the plurality of columns are arranged along a predetermined direction in R, G, B, IR order repeatedly. (For example, a column formed with the LED chips 64R is positioned next to a column formed with the LED chips 64G, the column formed with the LED chips 64G is positioned next to a column formed with the LED chips 64B, the column formed with the LED chips 64B is positioned next to a column formed with the LED chips 64IR, and the column formed with the LED chips 64IR is positioned next to a column formed with the LED chips 64R.)

The chip group 64A is disposed at a position below a conveying path of the photographic film 22 as shown in FIG. 3 such that an irradiating direction of the chip group 64A faces an irradiated surface of the photographic film 22. A filter 72 is disposed in the vicinity of an emitting surface of the chip group 64A. The filter 72 cuts off (blocks) infrared, which is an invisible light, emitted from the LED chips 64R, 64G and 64B and also transmits infrared emitted from the LED chip 64IR.

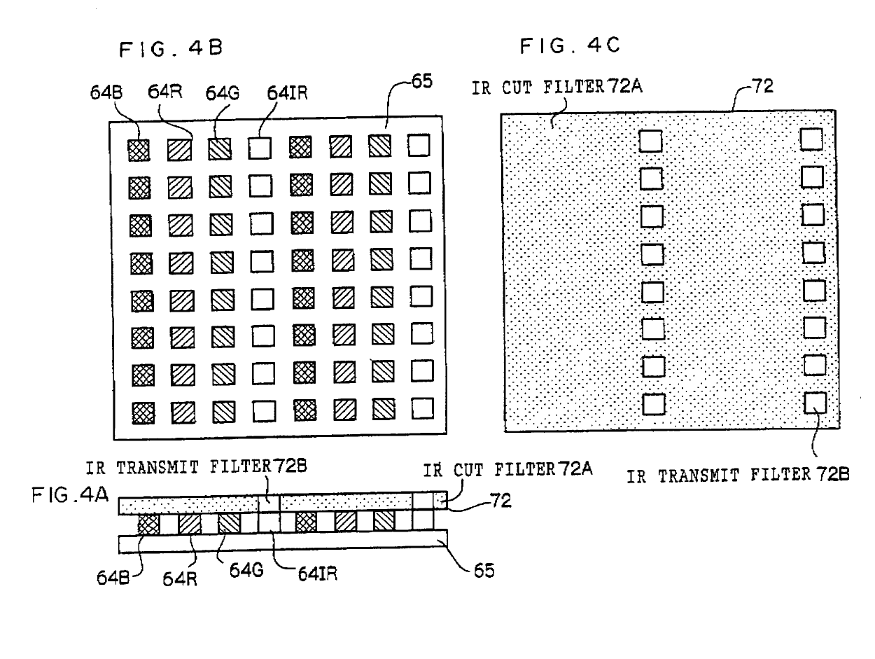

As shown in FIGS. 4A, 4B and 4C, the plate shaped filter 72 is structured such that the dimension and the configuration thereof is substantially the same as those of the substrate 65. The filter 72 is disposed on the emitting surface of the chip group 64A (see FIGS. 4A-4C). Portion of the filter 72, which faces the LED chips 64R, 64G and 64B, is formed of an IR cut filter 72A that cuts off infrared irradiated from the LED chips 64R, 64G and 64B (see FIG. 4C). Portions of the filter 72, which face the LED chips 64IR, are formed of IR transmitting filters 72B that transmit infrared irradiated from the LED chips 64IR (see FIG. 4C).

A mirror box 75 is disposed, above the filter 72, on an optical path of lights irradiated from the chip group 64A. The mirror box 75 suppresses divergence of lights transmitted through and exited from the filter 72.

The lights from the chip group 64A pass through the mirror box 75 and are guided toward the photographic film 22. Therefore, when the LED chips 64R, 64G and 64B emits respective lights of R, G and B, those lights of R, G and B transmit the IR cut filter 72A of the filter 72, pass through the mirror box 75, and are irradiated onto the photographic film 22.

Also, the lights from the LED chips 64IR transmit the IR transmitting filter 72B of the filter 72, pass through the mirror box 75, and are irradiated onto the photographic film 22 along an optical path which is the same as that of above mentioned lights of R, G and B.

At a side of the photographic film 22 carried out positioning and conveyed in a predetermined direction by a film carrier 74, opposite the side at which the light source section is located, a lens unit 77 and the CCD sensor 30 are disposed in that order along the optical axis of the LED chip group 64A. The lens unit 77, which is formed by at least one of an aspherical lens or a spherical lens, focuses the light which has been transmitted through the frame image of the photographic film 22.

A single lens is illustrated as the lens unit 77. However, the lens unit 77 is actually a zoom lens formed from a plurality of lenses. The lens unit 77 is for focusing the light which has been transmitted through the frame image of the photographic film 22 onto a predetermined position. The CCD sensor 30 is disposed at this predetermined position.

The CCD sensor 30 is an area type sensor in which a plurality of pixels, that detect light, are arranged in a matrix manner (two dimensional manner) along the direction in which the photographic film 22 is conveyed (the longitudinal direction of the photographic film 22) and the widthwise direction of the photographic film 22. The CCD sensor 30 has a function that accumulates electric charge in accordance with quantity of light received at each of the pixels.

The lights of colors R, G and B, or IR, transmitted through the frame image of the photographic film 22, are focused on substantially entire pixels of the CCD sensor 30 by the lens unit 77 and electrically read, per each frame image.

As mentioned above, the IR cut filter 72A blocks infrared emitted from the LED chips 64R, 64G and 64B, therefore, the infrared irradiated from the LED chips 64R, 64G and 64B does not reach the photographic film 22. On the other hand, the IR transmitting filter 72B transmits infrared irradiated from the LED chips 64IR, therefore, the infrared emitted from the LED chips 64IR reaches the photographic film 22. Accordingly, when reading the frame image of the photographic film 22 with irradiation light (visible light), non-uniformity of light quantity at a surface of the photographic film 22 can be suppressed. Further, quality of image reading is not lowered because infrared is not irradiated onto the photographic film 22. On the other hand, when detecting defect portion, infrared is not blocked by the filter 72. Accordingly, a portion of the frame image of the photographic film 22, in which light is scattered by blemish or the like, can be detected precisely.

Next, operation of the present embodiment will be explained.

When an operator inserts the photographic film 22 in the film carrier (negative film carrier) 74 and designates starting of reading frame image of the photographic film 22 by operating a key board 16K of the image processing section 16, a conveyance of the photographic film 22 is started at the film carrier 74. A preliminary reading (pre-scanning) is carried out at this conveyance of the photographic film 22. Namely, not only the frame image of the photographic film 22 is read by the CCD scanner 14, but also various types of data recorded on a portion other than an image recorded region of the photographic film 22 are read, while the photographic film 22 being conveyed with a relatively high speed. The read image is displayed on a monitor 16M.

Next, on the basis of the results of the preliminary scanning of each of the frame images, reading condition of re-reading of image (namely, reading condition of a fine scanning) for each of the frame images is set. When setting of reading conditions of the fine scanning for all frame images is completed, the photographic film 22 is conveyed in a direction opposite to the direction in which the photographic film 22 is conveyed at the time of the preliminary scanning, and the fine scanning for each of the frame images is carried out.

At this time, because the photographic film 22 is conveyed in the direction opposite to the direction in which the photographic film 22 is conveyed at the time of the preliminary scanning, the fine scanning is carried out from a final frame image to a first frame image in turn. The fine scanning is set such that a conveyance speed for the fine scanning is lower than that for the preliminary scanning. Accordingly, a reading resolution of the fine scanning is higher that that of the preliminary scanning accordingly.

Further, because a state of the image (for example, aspect ratio of photographed image, photographed state such as under, normal, over, or super over, whether or not an electronic flash (strobe) is used) is recognized at the time of the preliminary scanning, images are read with proper conditions at the fine scanning.

Further, blemish-erasing operation is carried out at the time of the fine scanning.

Namely, irradiating light of each color R, G, and B passes through the mirror box 75 such that divergence of light quantity is suppressed, and irradiated onto the photographic film 22. Then, after the light has transmitted through the photographic film 22, the light is focused on the CCD sensor 30 by the lens unit 77 and read per frame image. Thereafter, the LED chips 64IR emit infrared to detect a blemish on the film and/or a dust or the like on the optical path by the CCD sensor 30. Image correction (blemish-erasing) is carried out with respect to the image data obtained by reading image using each of R, G and B lights at the image processing section 16.

As described above, in the present embodiment, the LED chip group 64A is structured such that the LED chips 64R, 64G and 64B which emit respective lights of colors R, G and B, and the LED chips 64IR which emit infrared, are arranged closely (densely). The LED chip group 64A is disposed in the vicinity of the filter 72. Also, the LED chip group 64A is controlled such that emission of light of one color can be switched to that of another color. Therefore, when reading of image, the LED chip group 64A can emit respective R, G, B lights. Because portions of the filter 72, which face the LED chips 64R, 64G and 64B, are formed by the IR cut filter 72A that cuts off infrared irradiated from the LED chips 64R, 64G and 64B, infrared (invisible light) included in light irradiated from the LED chips 64R, 64G and 64B is cut off by the IR cut filter 72A. Therefore, infrared included in light irradiated from the LED chips 64R, 64G and 64B is not incident into the mirror box 75, namely, the infrared is not irradiated onto the photographic film 22. Accordingly, only irradiating lights of R, G and B can be used effectively, and degradation of quality of image, such as brightness lowering of the read image, is prevented.

On the other hand, when detecting defect portion, the LED chips 64IR can emit infrared. Because portions of the filter 72, which face the LED chips 64IR, are formed by the IR transmitting filter 72B that transmits infrared, infrared irradiated from the LED chips 64IR transmits through the IR transmitting filter 72B, and is irradiated onto the photographic film 22 via the mirror box 75. Accordingly, a defect portion on a surface of a photographic film can be detected precisely.

In the present embodiment, the area-type CCD sensor 30 is used in the CCD scanner. However, the present invention is not limited to the same. A liner CCD scanner, in which a line-type CCD sensor is used and image is read while conveying a film, can be applied to the present invention.

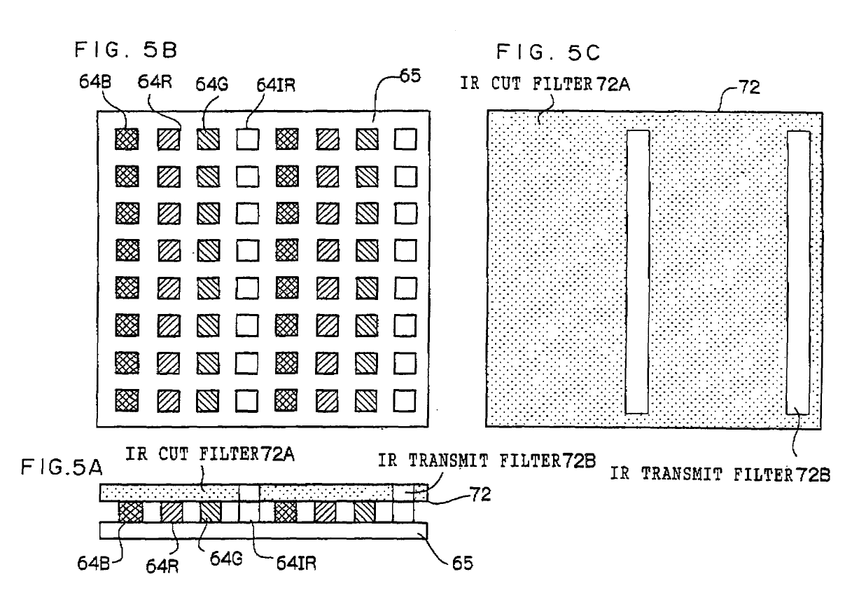

The filter 72 shown in FIGS. 5B and 5C can be applied to the present invention. In this filter 72, configuration of the IR transmitting filter 72B may be base on an arrangement column of the LED chips 64IR. More specifically, the LED chip group 64A is mounted on the substrate 65. This LED chip group 64A is structured such that there are a plurality of columns each formed by LED chips of respective colors. Namely, in the LED chip group 64A, a plurality of columns formed by a plurality of the LED chips 64R which emit light of color read (R), a plurality of columns formed by a plurality of the LED chips 64G which emit light of color green (G), a plurality of columns formed by a plurality of the LED chips 64B which emit light of color blue (B), and a plurality of columns formed by a plurality of the LED chips 64IR which emit infrared, are arranged (see FIG. 5B). The filter 72 is disposed on the emitting surface of the chip group 64A. The filter is plate shaped configuration, and the dimension and the configuration thereof is substantially the same as those of the substrate 65 (see FIGS. 5A-5C). Portions of the filter 72, which face (correspond to) the plurality of columns formed by respective LED chips of 64R, 64G and 64B, are formed by the IR cut filter 72A that cuts off infrared irradiated from the LED chips 64R, 64G and 64B (see FIG. 5C). Portions of the filter 72, which face (correspond to) the plurality of columns formed by LED chips 64IR, are formed by the IR transmitting filter 72B that transmits infrared irradiated from the LED chips 64IR (see FIG. 5C).

[Second Embodiment]

Hereinafter, the second embodiment of the present invention will be described. A structure of the second embodiment is substantially the same as that of the first embodiment. Therefore, the same reference numerals axe applied to the same components, members and structures as those of the first embodiment and the descriptions thereof are omitted.

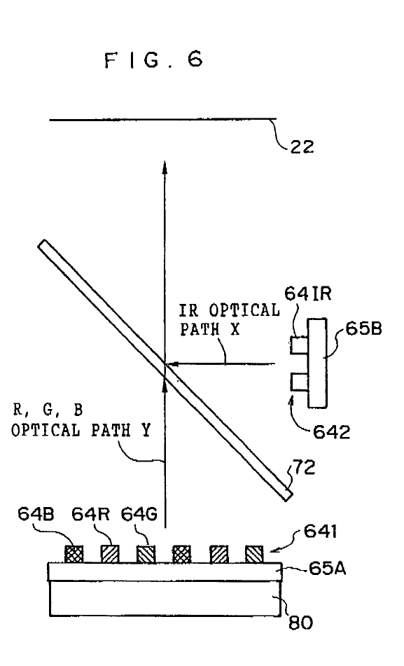

FIG. 6 is a side view illustrating the schematic structure of a light source section of a CCD scanner section 14. In FIG. 6, a mirror box is omitted for simplification. In FIG. 6, the mirror box is omitted for the sake of simplicity. The light source section includes a LED chip group 641 and a LED chip group 642. The LED chip group 641 is formed by a plurality of LED chips 64R, 64G and 64B, which emit respective lights of colors of a red (R), a green (G) and a blue (B), mounted on a substrate 65A.

The LED chip group 642 is formed by a plurality of LED chips 64IR, which emit infrared, mounted on a substrate 65B.

The LED chip group 641 is structured such that the LED chips 64R, 64G and 64B are arranged closely (densely) in a plane manner on the substrate 65A along a direction in which a photographic film 22 is conveyed (a longitudinal direction of the photographic film 22) and a widthwise direction of the photographic film 22 and arranged in R, G and B order in the similar way of the first embodiment. The LED chips are controlled such that respective lights of colors can be emitted independently (namely, emission of light of one color can be switched to that of another color). Therefore, the LED chip group 641 can emit respective R, G and B lights without non-uniformity of light quantity.

The LED chips 64R, 64G and 64B may be arranged on the substrate in a different manner. For example, the LED chips may be arranged such that there are a plurality of columns, each formed by LED chips of a single color one of R, G, and B being aligned in a line manner along a direction in which the photographic film 22 is conveyed (the longitudinal direction of the photographic film) or the widthwise direction of the photographic film, the plurality of columns are arranged along a predetermined direction in R, G, B order repeatedly.

The chip group 641 is disposed at a position below a conveying path of the photographic film 22, in FIG. 6, such that an irradiating direction of the chip group 64A faces an irradiated surface of the photographic film 22. A filter 72 is provided on an optical path, from the LED chip group 641 to the photographic film 22, of irradiating light (shown by an arrow Y in FIG. 6) between the LED chip group 641 and the photographic film 22 such that the filter 72 is inclined with respect to the optical path by angle 45 degree.

The filter 72 is a plate shaped IR cut filter and has a rectangle configuration. The filter 72 has characteristics in that lights of respective colors of R, G and B transmit the filter 72 and infrared reflects at the filter 72.

Accordingly, irradiating lights (visible lights) from the LED chip group 641 transmit through the filter 72, and reach the photographic film 22 via the mirror box which is not shown in the drawings (refer to the arrow Y in FIG. 6).

Further, the LED chip group 642, formed by LED chips 64IR emitting infrared, is positioned at the right and upper side with respect to the LED chip group 641 in FIG. 6. The LED chip group 642 is structured such that the LED chips 64IR are arranged closely (densely) in a column manner along a direction orthogonal to the direction in which the photographic film 22 is conveyed (the longitudinal direction of the photographic film) and the widthwise direction of the photographic film.

Light irradiated from the LED chips 64IR is reflected at the filter 72, which is disposed to be inclined with respect to a direction of the irradiated light of the LED chips 64IR by an angle 45 degree. Then, an optical axis of this reflected light and an optical axis of the light which is from the LED chip group 641 and transmits through this filter 72 coincide and are guided toward the photographic film via the mirror box which is not shown in the drawings (refer to the arrow X in FIG. 6).

When the LED chip group 641 emits lights of respective colors R, G and B, each light transmits through the filter 72 and is irradiated onto the photographic film 22 via the mirror box. When the LED chip group 642 emits infrared, the infrared reaches the photographic film 22 via the mirror box after the infrared is reflected at the filter 72. Namely, the optical path of the infrared is the same as that of the lights of respective colors R, G and B after the filter 72.

A temperature adjusting section 80 such as a peltier element or the like, is provided at a surface of the substrate 65A, which is opposite the surface at which the LED chips of the LED chip group 641 are mounted. The temperature adjusting section 80, on the basis of temperatures detected by a temperature detecting section such as a thermistor or the like at a periodic interval, maintains a temperature at a mounted portion of the LED chip group 641 by a predetermined temperature.

In the CCD scanner 14 of the second embodiment, when the LED chip group 641 emits lights of respective colors R, G and B, each light transmits through the filter 72, but light, whose wavelength is substantially the same as that of infrared, included in the lights of respective colors R, G and B, is reflected at the filter 72. Therefore, only the lights of respective colors R, G and B reach the photographic film 22, and the light whose wavelength is substantially the same as that of infrared does not reach the photographic film 22. Accordingly, degradation of quality of image, caused by sub-emission energy from the LED chip group 641 at the time of image reading, does not occur. On the other hand, when the LED chip group 642 emits infrared, the infrared is reflected at the filter 72 and reach the photographic film 22. (The optical path of the infrared is the same as that of the lights of respective colors R, G and B after the filter 72) Accordingly, a portion in which light is scattered due to a blemish or the like (a defect portion) can be detected precisely.

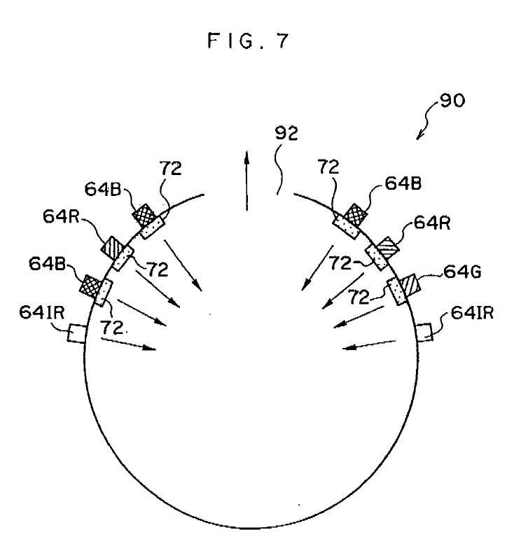

Further, as shown in FIG. 7, the present invention can be applied to so called an integrating sphere 90. On an interior surface of the integrating sphere 90, LED chips 64R, 64G and 64B for emitting respective lights of colors of a red (R), a green (G) and a blue (B), are mounted, and LED chips 64IR for emitting infrared, are mounted. These LED chips 64R, 64G 64B and 64IR are controlled such that emission of respective LED chips 64R, 64G 64B and 64IR can be switched. At each emitting surface of the respective LED chips 64R, 64G and 64B, an IR cut filter 72, that cuts off infrared but transmits lights of respective colors of R, G, B, is provided.

When each of the LED chips 64R, 64G and 64B emit light, each of lights of colors of R, G and B from the respective LED chips 64R, 64G 64B transmits through the IR cut filter 72. Then, the each of lights of the colors is reflected at the interior surface of the integrating sphere 90 and exits from an exit opening 92 of the integrating sphere 90. At this time, infrared included in each light emitted from the respective LED chips 64R, 64G and 64B is cut by the IR cut filter 72, and does not exit from the exit opening 92. Accordingly, because the infrared included in the lights emitted from the LED chips 64R, 64G and 64B does not exit from the exit opening 92, degradation of quality of image, caused by sub-emission energy of the LED chips 64R, 64G and 64B at the time of image reading, does not occur.

On the other hand, infrared emitted from the LED chips 64IR is reflected at the interior surface of the integrating sphere 90 and exits from the exit opening 92. Accordingly, a blemish, a dust or the like can be detected precisely.

A transparent original such as the photographic film is used in the embodiments of the present invention described above, however, the present invention is not limited to the same. The present invention can be applied to image reading for a reflective original.

Moreover, as an invisible light for detecting a blemish or the like on an original, not only infrared but also ultraviolet can be used in the optical system.

In the embodiments described above, the light source device includes the LED chips 64R, 64G and 64B, and also includes the LED chips 64IR emitting light in infrared wavelength range (infrared) for detecting a blemish or the like. However, the present invention is not limited to the same. Namely, the present invention can be applied to a light source device which includes only LEDs having main energy thereof in wavelength range of visible light. For example, the present invention can be applied to a light source device that does not includes LEDs emitting infrared but include LEDs emitting visible lights, for example, lights of red, green and blue in wavelength range of visible light.

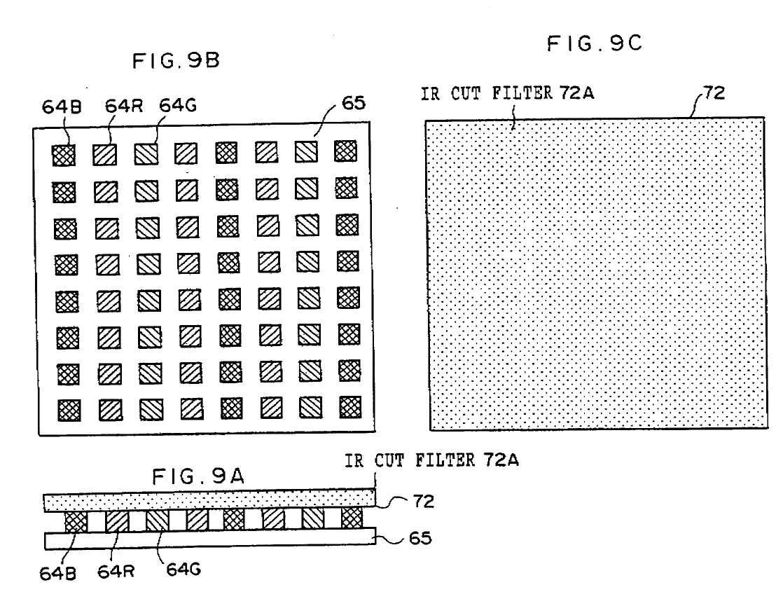

A light source device which enables to emit visible lights on the photosensitive film 22 is shown in FIGS. 9A, 9B and 9C. The optical system is provided with a substrate 65 on which a LED chip group is mounted. The LED chip group includes a plurality of LED chips 64R, 64G and 64B. The LED chips 64R, 64G and 64B emit respective lights of colors of red (R), green (G) and blue (B). The LED chip group is disposed at a position below a conveying path of the photographic film 22 such that an irradiating direction of the LED chip group faces an irradiated surface of the photographic film 22. A filter 72 is disposed in the vicinity of an emitting surface of the LED chip group. The filter 72 cuts off (blocks) infrared, which is invisible light, emitted from the LED chips 64R, 64G and 64B.

As shown in FIGS. 9A, 9B and 9C, the plate shaped filter 72 is structured such that the dimension and the configuration thereof is substantially the same as those of the substrate 65, and the filter 72 is disposed on the emitting surface of the LED chip group. At least a portion of the filter 72, which faces the LED chips 64R, 64G and 64B, is formed of an IR cut filter 72A that cuts off infrared irradiated from the LED chips 64R, 64G and 64B (see FIG. 9C). Namely, the filter 72 is structured and disposed such that it can uniformly cut infrared irradiated from each LED (see FIG. 9C).

Accordingly, even if respective lights from the LED chips 64R, 64G and 64B include infrared which is invisible light, the infrared is cut by the IR cut filter 72. Namely, infrared emitted from the LED chips 64R, 64G and 64B together with respective R, G, B lights is cut by the IR cut filter. Therefore, infrared is not irradiated onto the photographic film 22. Accordingly, because infrared is not irradiated onto the photographic film 22 at the time of emission of the LED chips 64R, 64G and 64B, degradation of quality of image, caused by sub-emission energy of the LED chips 64R, 64G and 64B at the time of image reading, does not occur.

As mentioned above, in accordance with the present invention, blemish-erasing for an original can be carried out precisely while degradation of quality of read image does not occur.

What is claimed is:

1. A light source device comprising:
a first light source section that emits a first light for reading image information of an image recorded on a transparent original or a reflection original;
a second light source section that emits a second light for detecting a defect on the original or on an optical path; and
a filter that blocks light, included in the first light, whose wavelength is substantially the same as that of the second light.

2. The light source device of claim 1, wherein
the first light source section is a first light emitting element group formed by a plurality of light emitting elements that emit lights having different wavelengths on the basis of wavelengths of the colors of red, green and blue, and
the second light source section is a second light emitting element group formed by a plurality of light emitting elements that emit infrared light.

3. The light source device of claim 2, wherein the filter is disposed in the vicinity of an emitting surface of the first light emitting element group.

4. The light source device of claim 2, wherein the first light emitting element group and the second light emitting element group are mounted on respective separated substrates.

5. The light source device of claim 3, wherein the first light emitting element group and the second light emitting element group are mounted on respective separate substrates.

6. The light source device of claim 4, wherein an axis of an optical path of light emitted from the second light emitting element group and reflected at the filter is the same as an axis of an optical path of light emitted from the first light emitting element group and transmitted through the filter.

7. The light source device of claim 2, wherein the first light emitting element group and the second light emitting element group are both disposed on a single substrate, and the filter is mounted on only an emitting surface of the first light emitting element group.

8. The light source device of claim 3, wherein the first light emitting element group and the second light emitting element group are both disposed on a single substrate, and the filter is mounted on only an emitting surface of the first light emitting element group.

9. The light source device of claim 4, further comprising:
a temperature detecting section for detecting a temperature at a portion of the substrate on which the first light emitting element group is mounted; and
a temperature adjusting section for adjusting the temperature at the portion of the substrate on which the first light emitting element group is mounted on the basis of the temperature detected by the temperature detecting section.

10. The light source device of claim 7, further comprising:
a temperature detecting section for detecting a temperature at a portion of the substrate on which the first light emitting element group is mounted; and
a temperature adjusting section for adjusting the temperature at the portion of the substrate on which the first light emitting element group is mounted on the basis of the temperature detected by the temperature detecting section.

11. An image reading apparatus, in which an image recorded on a transparent original or a reflection original is read, comprising:
a light source device including
a first light source section that emits a first light for reading image information of the image,
a second light source section that emits a second light for detecting a defect on the original or an optical path, and
a filter that blocks light, included in the first light, whose wavelength is substantially the same as that of the second light, and
an image reading section for reading the image information of the image recorded on the original by receiving light that is emitted from the light source device and reflected by or transmitted through the original.

12. The light source device of claim 4, wherein the filter transmits through lights having wavelengths of colors of the red, green and blue, and the infrared is reflected at the filter.

13. The light source device of claim 6, wherein the first light source section and the second light source section are disposed such that an emitting surface of the first light source section and an emitting surface of the second light source section are substantially orthogonal to each other, and
the filter is disposed such that a surface thereof is inclined by substantially 45 degrees with respect to the respective irradiating surfaces.

14. A light source device comprising:
a light source section that emits a light for reading image information of an image recorded on a transparent original or a reflection original; and
a filter that blocks invisible light included in the light emitted from the light source,
wherein the light source section is a light emitting element group formed by a plurality of light emitting elements that emit lights having different wavelengths on the basis of wavelengths of the colors of red, green and blue.

15. The light source device of claim 14, wherein the filter is disposed in the vicinity of an emitting surface of the light emitting element group.
